(19) United States
(12) Patent Application Publication
(10) Pub. No.: US 2002/0076217 A1
(43) Pub. Date: Jun. 20, 2002

(54) Methods and apparatus for automatic recording of photograph information into a digital camera or handheld computing device

(75) Inventors: Herman Rodriguez, Austin, TX (US); Newton James Smith JR., Austin, TX (US); Clifford Jay Spinac, Austin, TX (US)

Correspondence Address: Rudolf O. Siegesmund, Suite 2000, 4627 N. Central Expressway, Dallas, TX, 75205-4022, US

(73) Assignee: IBM Corporation

(21) Appl. No.: 09/738,249

(22) Filed: Dec. 15, 2000

(51) Int. Cl. G03B 17/00

(52) U.S. Cl. 396/72; 396/429

(57) ABSTRACT

An information system for communication between a digital camera and bidirectional device that is located in proximity to a photographic site is disclosed. In the absence of the digital camera, the bidirectional device may provide communication with a personal digital communication device (PDCD) carried by the photographer. The digital camera may transmit preferences and camera data to the bidirectional device so that customized information, prepared by an information provider, may be automatically transmitted to the digital camera or PDCD or, via the Internet, to the photographer's e-mail address. A standardized photographic identification data packet (PIDDP) may be defined for use by the digital camera or the PDCD, for communication with the bidirectional device. The PIDDP may be transmitted by means of radio frequency, infrared, Bluetooth enabled transmission, or any other transmission method. The information system is implemented by a method for automatically recording information related to a photograph into the communication device in a digital camera or PDCD.

### TECHNICAL FIELD

This invention relates to a method and apparatus for automatically recording information related to a photograph into a digital camera or a handheld computing device.

### BACKGROUND OF THE INVENTION

When a photographer takes a photograph or captures a digital image at a well know site such as a sightseeing, tourist, or business location, the photographer may need to remember information related to the site which is the subject of the photograph taken, or the image captured. Additionally, the photographer may desire to record the information at the time that the photograph is taken or that the image is captured. Storage of information on a film, or in the memory of a digital camera, is well known. However, such storage of information is done in an ad hoc and often incomplete manner. The photographer must already know, or must look up, information about the subject of the photograph or digital image from a source that may not be related to, or in proximity to the camera at the time the photograph is taken or the image is captured. For example, the photographer may look up the information from a travel information book or from a published reference document. Information about the site which is the subject of the photograph or digital image is often important for business reasons such as record keeping, brochures and flyers, or for personal reasons such as enjoyment of photograph albums or transmission of digital images to friends and family.

U.S. Pat. No. 5,699,244, entitled “Hand-Held GUI PDA with GPS/DGPS Receiver for Collecting Agronomic and GPS Position Data,” describes a compact handheld graphic user interface personal digital assistant computer that is coupled to a GPS/dGPS receiver module to provide for the collection of data associated with position information. U.S. Pat. No. 6,065,880, entitled “Laser Enhanced Personal Data Assistant,” describes an adapter configured for removable attachment to a conventional PDA. U.S. Pat No. 6,088,730, entitled “Methods and Apparatus for Downloading Data Between an Information Processing Device and an External Device Via a Wireless Communications Technique,” describes methods and apparatus for periodically accessing a predetermined server machine to acquire a desired file without the involvement of operations of an infrared transceiver. U.S. Pat. No. 5,778,256, entitled “PDA Having a Separate Infrared Generating Device Connected to Its Printer Port for Controlling Home Appliances,” describes a personal digital assistant having transmission capabilities using infrared frequency for control purposes. U.S. Pat. No. 5,675,524, entitled “Portable Apparatus for Providing Multiple Integrated Communication Media,” describes a communication device for a personal digital assistant which connects electronically to a serial port on the personal digital assistant.

In addition, some cameras are known to allow a user to store information about the photograph by recording the user's voice and saving the recorded voice information in the camera. However, cameras with voice recording capability require the photographer both to speak and to have possession of the desired information at the time the photograph is taken. Therefore, a need exists for an information system that does not require the photographer to speak at the time the photograph is taken, and that does not require the photographer to personally know and remember information about the site at the time the photograph is taken. In addition, a need exists for an electronic information provider to offer information to a photographer that can be received by the photographer at the time the photograph is taken.

### SUMMARY OF THE INVENTION

The invention which meets the needs identified above is an information system for communication between a digital camera and a bidirectional device that is located in proximity to the photographic site. In the absence of the digital camera, the bidirectional device may provide communication with a personal digital communication device (PDCD) carried by the photographer. The digital camera may transmit preferences and camera data to the bidirectional device so that customized information, prepared by an information provider, may be automatically transmitted to the digital camera or PDCD, or via the Internet, to the photographer's e-mail address. A standardized photographic identification data packet (PIDDP) may be defined for use by either the digital camera or the PDCD, for communication with the bidirectional device. The PIDDP may be used to communicate or transmit preferences and camera data to the bidirectional device and to transmit the customized information to the photographer. The PIDDP may be transmitted by means of radio frequency, infrared, Bluetooth enabled transmission, or any other transmission method. The information system is implemented by a method for automatically recording information related to a photograph into the communication device in a digital camera or PDCD.

### BRIEF DESCRIPTION OF THE DRAWINGS

The present invention will now be described, by way of example, with reference to the accompanying drawings, in which:

FIG. 1 is a drawing depicting a general situation wherein the present invention is applicable;

FIG. 1a is a block diagram of a digital camera;

FIG. 1b is a block diagram of a personal digital communication device;

FIG. 1c is a block diagram of a communication device;

FIG. 2 is a schematic showing the automatic information system;

FIG. 3 is flowchart depicting the automatic information process;

FIG. 4 is a drawing that depicts an independent automatic information system; and

FIG. 5 is a drawing that depicts an indirect automatic information system.

### DESCRIPTION OF THE PREFERRED EMBODIMENT

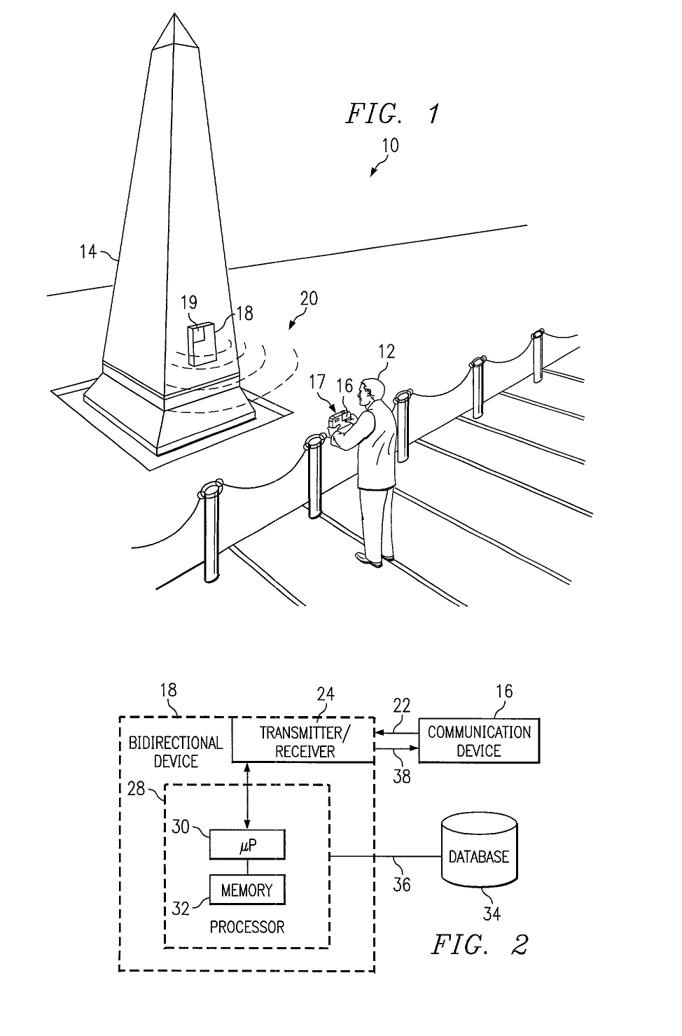

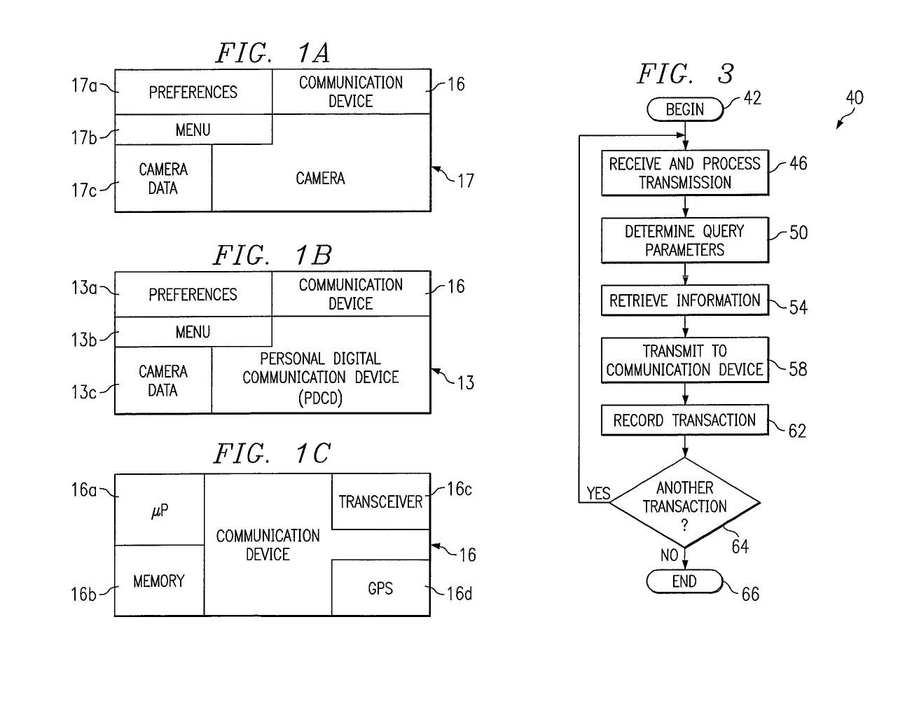

FIG. 1 shows automatic information system 10. Photographer 12 intends to take a photograph of object 14. Object 14 may be a national monument, tourist attraction, famous building, historic location or other commonly photographed site. Transmitter/receiver 24 (See FIG. 2), included within bidirectional device 18, is located in proximity to object 14. For example, transmitter/receiver 24 may be located within a plaque that is used to describe the importance of the site. Photographer 12 has communication device 16 which, in the preferred embodiment, is contained within digital camera 17. Bidirectional device 18 may contain information 19, or in the alternative, information 19 may be stored in proximity to bidirectional device 18. As used herein, the term information includes, without limitation, information about the site or object to be photographed, such as a history of the site, details of the site's construction, a summary of people and events associated with the site, recorded speeches given at the site, noteworthy films or photographs previously taken of the site, or such other information that an information provider may determine would be of value to a photographer. In addition, the information about the site or object may be furnished in various languages as deemed appropriate by the information provider. As used herein, the term information includes, without limitation, data in the form of graphical, textual, audio, video, and Global Positioning System (GPS ) files. The term information may also include camera data, such as the camera's focal length and shutter speed, to give information about the photograph where the camera data has been transmitted to bidirectional device 18. A standardized photographic identification data packet (PIDDP) may be defined for use either by the digital camera, or by the PDCD for communication with bidirectional device 18. The PIDDP may be used by communication device 18 for sending preferences and camera data to bidirectional device 18. In addition, the PIDDP may be used to send information 19 from bidirectional device 18 to communication device 16. The PIDDP may be transmitted from either communication device 16 or bidirectional device 18 by means of radio frequency, infrared, Bluetooth enabled transmission, or any other transmission method. As used herein the term Bluetooth means a wireless personal area network (PAN) technology from the Bluetooth Special Interest Group founded by Ericsson, IBM, Intel, Nokia and Toshiba. Bluetooth is an open standard for short-range transmission of digital voice and data between mobile devices, such as laptops, personal digital assistant (PDA) devices, phones, and desktop devices. Bluetooth supports point to point and multipoint applications. Further in the alternative, information 19 may be electronically linked to bidirectional device 18 from a remote location (not shown). Choices of language and other user preferences may be stored in digital camera 17, or in personal digital communication device (PDCD) 13, and be transmitted with the information request allowing customization of preferences 17a (see FIG. 1A) for data transmitted from the information provider. The transmissions may be directional so that data on orientation of photographer 12 may be included in information 19. For example, orientation data may indicate that photographer 12 was facing the northeast corner of the building in which the photograph was taken, or that the view of the city captured in the photograph was toward the south.

Photographer 12, upon deciding to take a photograph with digital camera 17, focuses digital camera 17 to a focal point (not shown) within an area in proximity to bidirectional device 18. The focal point may not be located upon bidirectional device 18; however, bidirectional device 18 must be in proximity to the focal point so that bidirectional device 18 may be properly informed of the existence of photographer 12 by receipt of an electronic signal within a predetermined region 20.

FIG. 1a shows digital camera 17 for use in the present invention. In addition to the usual camera functions, digital camera 17 also contains communication device 16 and storage for preferences 17a, which are selected via a menu 17b. Preferences 17a communicate the photographer's request to bi-directional device 18, and include such things as the amount of information, (summary or full detail), the subject of the information (historical, contemporary, etc.), the type of information (text, audio, graphics, image), the language in which the textual portion of information is to be provided, the destination to which the information is to be sent (i.e., to the camera, to a PDCD, or to an e-mail address), and information about the make, model, and configuration of the camera or PDCD. Preferences 17a and camera data 17c are transmitted via communication device 16 to bi-directional device 18. A table in memory 32 of bi-directional device 18 stores camera and PDCD models and their capabilities. Bi-directional device 18 then supplies information 19, which is the requested information based on preferences 17a and camera data 17c, to the specified destination. In the event certain information is not available (e.g. audio), a message is sent informing photographer 12. Based upon preferences 17a (or PDCD preferences 13a, see FIG. 1B) and camera data 17c (or PDCD camera data 13c), information 19 is formatted and returned to camera 17 or PDCD 13 of photographer 12. For example, some cameras may accept audio in the MP3 format while others would required WAV. As used herein, the term MP3 means MPEG1 Layer 3 (Audio), a digital coding scheme used in distributing recorded music over the Internet. The acronym MPEG stands for Moving Pictures Experts Group and is a set of standards for audio and video compressions established by the Joint ISO/TEC Technical Committee on Information Technology. As used herein, WAV means a file format in which Windows stores sounds as waveforms.

FIG. 1B shows a personal communications device (PDCD) 13 which would be used with a non-digital camera or a digital camera without the additional features described above. The term PDCD shall include, but not be limited to, Personal Digital Assistant (PDA) devices. As used herein, PDA means a lightweight palmtop computer designed to provide specific functions for personal organization as well as communications. A PDA may offer multimedia features, and may rely on flash memory for data storage. Personal Digital Communication Device 13 communicates a request by photographer 12 to bi-directional device 18 and, when bi-directional device 18 transmits information 19 in response, PDCD 13 receives information 19.

FIG. 1C shows communication device 16 which transmits a request from photographer 12 to bi-directional device 18. Communication device 16 contains transceiver 16c for communication with bidirectional device 18 (or the Internet as will be discussed further below), memory 16b to store information 19 when received, and microcontroller 16a. Memory 16b may be non-volatile storage dedicated to communication device 16, may be contained within digital camera 19 or PDCD 13 (e.g., a hard disk), or may be a removable memory card. Information 19 may also include precise location information. Precise location information may be necessary if photographs are being taken for documentary or legal reasons. In these cases, the location of photographer 12 can be determined using GPS device 16d in communication device 16 (which may be included in digital camera 17 or PDCD 13). GPS data from GPS device 16d may be combined with the known location of object 14 and included in information 19 for storage in digital camera 19 or PDCD 13.

Referring to FIG. 2, a more detailed description of the present invention in relation to FIG. 1 is described. Communication device 16 initiates a first wireless transmission 22 that is received by transceiver 24 of bidirectional device 18. Transceiver 24, in turn, communicates with processor 28 wherein first wireless transmission 22 is processed. Processor 28 has micro-controller 30 coupled to memory 32. Processor 28 is coupled to database 34 by path 36. Database 34 contains information 19. If a determination is made that some portion of information 19 is needed, the relevant portions are read out by processor 28 via path 36 and written to transceiver 24 or to a data buffer (not shown) contained therein. In turn, the relevant portions of information 19 are transmitted to communication device 16 via second wireless communication path 38.

FIGS. 1 and 2 may be explained further by way of an example. When photographer 12 intends to take a picture of monument 14, photographer 12 comes into predetermined region 20. Photographer 12 points digital camera 17 at the point of interest to photographer 12. Communication device 16 associated with digital camera 17 transmits a signal that comprises a PIDDP containing preferences 17a and camera data 17c. The PIDDP traverses first communication path 22. The signal containing the PIDDP is received by transceiver 24 and processed by processor 28. Processor 28 sends a query to database 34 via first communication path 36. A portion of information 19 is read from database 34 and returned to processor 28. In turn the portion of information 19 is sent to transceiver 24 and transmitted to communication device 16 via second communication path 38.

Database 34 may be remote in relation to bidirectional device 18. First communication path 36 may be achieved by wireless means, or may be achieved by hardwiring. For example, bidirectional device 18 may be coupled to a local area network (LAN) that may be wireless or wired. Alternatively, bidirectional device 18 may be coupled to a wide area network (WAN) including, but not limited to, the Internet. Persons skilled in the art will be aware of additional types of suitable networks. Information 19 may be updated by its content owner from time to time as needed. Furthermore, information 19 may comprise text or graphic data, audio data, video, or even control related data. Bidirectional device 18 may be a simple, compact device including processor 28, transceiver 24 and database 34, or in the alternative, bidirectional device 18 may have alternative components. For example, database 34 may be stored in an erasable programable read-only memory (EPROM), and processor 28 may be a commercially available single compact chip.

FIG. 3 shows automatic information process 40. Information process 40 begins (42) and transceiver 24 receives first wireless transmission 22 from communication device 16. First wireless transmission 22 is received and processed by processor 28 (46). First wireless transmission 22 may include a PIDDP with a first set of parameters, such as camera data 17a and preferences 17c, which is conveyed to bidirectional device 18. Next, a determination of a set of query parameters is made (50); that is, processor 28 determines a set of control data or signals, whereby part of information 19 stored within database 34 is retrieved (54). For example, part of information 19 stored within database 34 may be read into a buffer within bidirectional device 18. Information 19 is transmitted to a receiving device such as communication device 16 (58). The data from the above steps is defined as a transaction and the data is stored (62). For example, micro-controller 16a may record the transaction in some format within its internal registers, or write the transaction into memory 16b (See FIG. 1C). In addition, information about such transactions may be retained in bidirectional device 18, such as number of requests, languages requested, and type of information requested. A determination is made whether there is another transaction (64). If it is determined that another transaction is requested, the above process returns to step 46. If no transaction is requested, the process ends (66).

As can be appreciated, the present invention describes methods and apparatus that allow a photographer to obtain and record information 19 about a photograph automatically. Furthermore, the present invention teaches automatic storage of information 19 in a digital camera with which the photograph was taken, or a PDCD if the camera is not enabled. Information 19 is recorded automatically and transmitted at the site where the photograph is taken. Therefore, no manual intervention by photographer 12 is required. Information 19 may be professionally mastered and made available for transmission by an information provider, by a site owner, or by a content owner. For example, a user who takes a picture of the Statue of Liberty would focus his camera on a particular point of interest of the monument. The United States Park Service would provide digital information that would be transmitted wirelessly to the photographer's equipment. Information 19 could be enhanced further if it was based on the proximity of the photographer in relation to the focal point of digital camera 17. Therefore, if photographer 12 desires to take a photograph of the Statue of Liberty, photographer 12 may choose to photograph a plaque in front of the statue. Transmission of the focal length of digital camera 17 would enable bidirectional device 18 to distinguish between a photograph of the plaque or a photograph of the statue itself. Bidirectional device 18 would send different information based upon whether the photograph was of the plaque or the statue itself.

In another embodiment, bidirectional device 18 would transmit a menu, available to receivers within range, that would allow photographer 12 to choose various levels of information or various subsets of information. In the example of the Statue of Liberty, photographer 12 could choose from a menu that would allow information to be requested concerning the Statue alone, the plaque alone, or the Statue and plaque together. The foregoing embodiment is especially useful when photographer 12 is using a PDCD to request the information and the camera focal length is not available.

The present invention can be embodied in the form of computer-implemented processes and apparatuses for practicing those processes. The present invention can also be embodied in the form of computer program code containing instructions embodied in tangible media, such as floppy diskettes, CD-ROMs, EPROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

Referring to FIG. 4, independent automatic information system 80 of the present invention is depicted that addresses the situation where camera 17 does not contain communication device 16. However, photographer 12 has PDCD 13 that can communicate independently and directly with bidirectional device 18. For example, either photographer 12 is using a non-digital camera, or digital camera 16 (not shown here) is not compatible with bidirectional device 18 for communication purposes. Using PDCD 13, which is separate yet in proximity to the camera (not shown) in use by photographer 12, first wireless transmission 22 is initiated. Transceiver 24 of bidirectional device 18, in turn, receives first wireless transmission 22. Transceiver 24 in turn communicates to processor 28 wherein first wireless transmission 22 is processed. Processor 28 has micro-controller 30 coupled to memory 32. Processor 28 is also coupled via path 36 to database 34 where information 19 is stored. If a determination is made that some portions of information 19 are needed, the relevant portions are read out by processor 28 via path 36, and written to transceiver 24, or into a data buffer (not shown) contained therein. In turn, the relevant portions of information 19 are transmitted to communication device 13 via second wireless communication path 38.

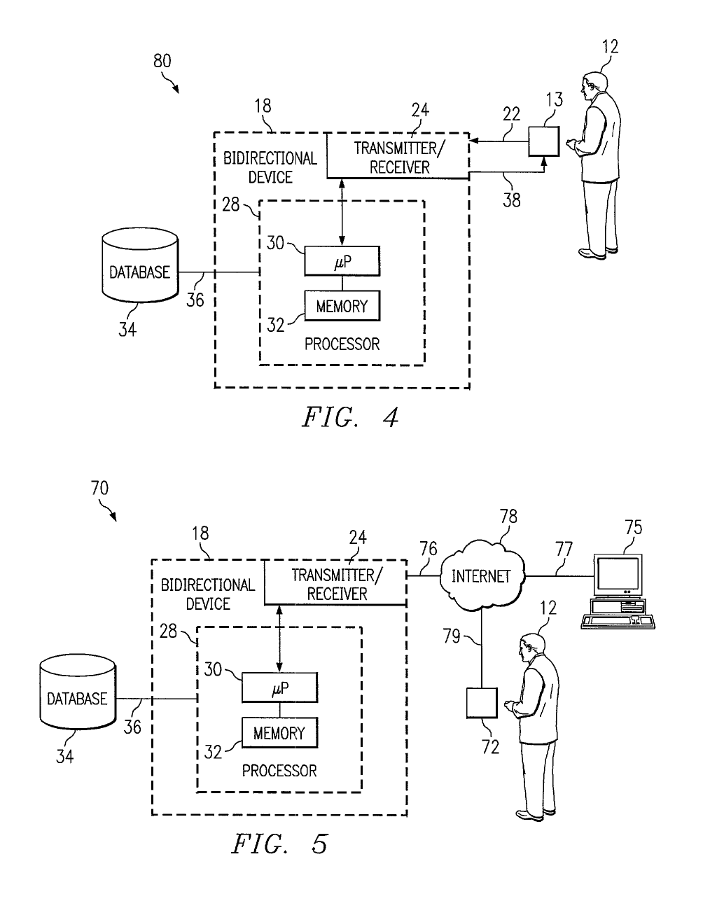

Referring to FIG. 5, indirect automatic communication system 70 is depicted that addresses a situation where communication device 16 is nonexistent or inapplicable. For example, photographer 12 may be using a non-digital camera, or photographer 12 may be using digital camera 19 (not shown here) that is not compatible with bidirectional device 18 for communication purposes. Using independent communication device 72, which is separate yet in proximity to the camera (not shown) in use by the photographer 12, first wireless transmission 79 is initiated to Internet 78. Transceiver 24 of bidirectional device 18 receives first wireless transmission 79 through third wireless communication path 76 which connects bidirectional device 18 to Internet 78. Transceiver 24, in turn, communicates to processor 28 wherein first wireless transmission 79 is processed. Processor 28 has micro-controller 30 coupled to memory 32. Processor 28 is also coupled by path 36 to database 34 where information 19 is stored. If a determination that some portions of information 19 are needed, the relevant portions are read out by processor 28 via path 36, and written to transceiver 24, or a data buffer (not shown) contained therein. In turn, the relevant portions of information 19 are transmitted to independent communication device 72 via third wireless communication path 76 to Internet 78. In turn, Internet 78 relays relevant portions of information 19 to independent communication device 72 and, optionally, to the user's home computer 75. For example, if information 19 is too large for the memory of independent communication device 72, bidirectional device 18 can transmit information 19 to the photographer's e-mail address. Another example, of a situation where information would be transmitted to the photographer's e-mail address, is that occurring when the PDCD does not have audio capabilities but photographer 12 desires audio information. In order to communicate with bidirectional device 18, photographer 12 must have the Internet Protocol Address (IP address) of bidirectional device 18. Bidirectional device 18 may make its IP address available to photographer 12 from a menu selection. Alternatively, the IP address of bidirectional device 18 may be made available to photographer 12 from a website related to object 14 or by posting the IP address in the vicinity of object 14. As used herein, the term IP address means a 32-bit (4-byte) binary number that uniquely identifies a computer connected to the Internet to other Internet computers, for the purposes of communication through the transfer of packets.

As can be appreciated, the present invention teaches a method for automatically recording information related to a photograph into a communication device. The method includes providing a focal point, and providing a bidirectional device in proximity to the focal point, as well as determining a set of information related to the focal point. The method further includes receiving a signal from the communication device, and transmitting part of the set of information, so that information related to the focal point is received by the communication device when a photograph is taken by a camera.

The present invention further teaches a communication system for automatically recording information related to a photograph into a communication device. The communication system includes a focal point, a camera focused onto a point at least in proximity to the focal point, and a communication device associated with the camera capable of transmitting a signal toward the focal point, as well as a set of information related to the focal point being transmitted toward the communication device, whereby the information related to the focal point is automatically recorded and later combined with a photo taken by the camera.

It will be understood that a person skilled in the art may make modifications to the preferred embodiment shown herein within the scope and intent of the claims. While the present invention has been described as carried out in a specific embodiment thereof, it is not intended to be limited thereby but intended to cover the invention broadly within the scope and spirit of the claims.

What is claimed is:

1. A method for automatically recording information into a communication device, comprising:
selecting a focal point;
providing a bidirectional device in proximity to said focal point;
receiving a signal in said bidirectional device from said communication device;
responsive to said signal, determining a set of information related to said focal point; and
transmitting part of said set of information, so that information related to said focal point is received by said communication device when a photograph is taken by a camera.

2. The method of claim 1 wherein a camera data is transmitted in said signal to said bidirectional device in order to determine a set of information to be transmitted.

3. The method of claim 1 wherein a preference is transmitted in said signal to determine a set of information to be transmitted.

4. The method of claim 1 further comprising s electively retrieving part of said set of information from a database.

5. The method of claim 1 further comprising, responsive to receiving the focal length of said camera, determining the distance of said camera from said focal point.

6. The method of claim 1 further comprising transmitting said information to said communication device.

7. The method of claim 1 further comprising combining the transmitted part of said set of information with said photograph.

8. The method of claim 1 wherein said communication device is contained within said camera.

9. The method of claim 1 wherein said communication device is separate from said camera.

10. The method of claim 1 wherein said communication device comprises a personal digital communication device.

11. The method of claim 1 wherein said communication device communicates with said bidirectional device through the Internet.

12. The method of claim 1 further comprising using a menu for selection of preferences.

13. The method of claim 1 further comprising providing a menu for selection of various information subsets.

14. The method of claim 1 further comprising providing an IP address for said bidirectional device to said communication device.

15. The method of claim 1 further comprising sending data to a user's e-mail address.

16. A storage medium encoded with machine-readable computer program code for automatically recording information into a communication device, said storage medium including instructions for causing a computer in a bidirectional device to receive a signal from said communication device; responsive to said signal, determining a set of information related to a focal point; and transmitting part of said set of information so that information related to said focal point is received by said communication device when a photograph is taken by a camera.

17. The storage medium of claim 16 further comprising instructions for causing said computer to selectively retrieve part of said set of information from a database.

18. A programmable apparatus for sending a set of information from an information provider to a photographer comprising:
programmable hardware comprising;
a bidirectional device; and
a communication device;
a network connecting said bidirectional device and said communication device;
a first program installed on a first memory in said bidirectional device;
a second program installed on a second memory in said communication device; and
wherein, responsive to said bidirectional device receiving a request from said communication device, said bidirectional device transmits a set of information to the communication device.

19. The programmable apparatus of claim 18 wherein said second program causes said communication device to determine the distance of said camera from said focal point.

20. The programmable apparatus of claim 18 wherein, responsive to receipt of a set of information from said bidirectional device, said communication device combines said set of information with a photograph according to instructions from said second program.

21. The programmable apparatus of claim 18 wherein said network is a direct wireless communication path between said bidirectional device and said communication device.

22. The programmable apparatus of claim 18 wherein said network comprises the bidirectional device having an IP and a personal digital communication device adapted for communication with said bidirectional device via the Internet.

23. The programmable apparatus of claim 18 wherein said network comprises the bidirectional device having an IP address, a PDCD adapted for communication with said bidirectional device via the Internet, and the photographer's personal computer having an e-mail address; wherein, responsive to a request for a set of information from said PDCD, said bidirectional device transmits said set of information to said e-mail address.

24. A communication system for automatically recording photographic information into a communication device comprising:
a focal point;
a camera focused onto a point at least in proximity to said focal point;
a communication device associated with said camera capable of transmitting a signal toward said focal point; and
a set of information related to said focal point adapted for transmission to said communication device, whereby said information related to said focal point is automatically recorded and later combined with a photo taken by said camera.

25. The communication system of claim 24 further comprising a bidirectional device for receiving said signal and transmitting said set of information related to said focal point to said communication device associated with said camera.

26. The communication system of claim 24 wherein said signal comprises a PIDDP.

27. The communication system of claim 24 wherein said communication device is contained within said camera.

28. The communication system of claim 24 wherein said set of information comprises graphical data.

29. The communication system of claim 24 wherein said set of information comprises textual data.

30. The communication system of claim 24 wherein said set of information comprises video data.

31. The communication system of claim 24 wherein said set of information comprises audio data.

32. A communication system of claim 24 wherein said set of information comprises factual information about a site in proximity to said focal point.

33. The communication system of claim 24 wherein said set of information is sent to a user's e-mail address via the Internet.
